(19) United States
(12) Patent Application Publication
(10) Pub. No.: US 2025/0233185 A1
(43) Pub. Date: Jul. 17, 2025

(54) PRODUCTION METHOD AND PRODUCTION SYSTEM FOR PRODUCING A FUEL CELL STACK

(71) Applicant: Robert Bosch GmbH, Stuttgart (DE)

(72) Inventors: Nadine Dannehl, Ludwigsburg (DE); Danilo Rene Neuber, Stuttgart (DE); Moritz Waldorf, Wuppertal (DE)

(21) Appl. No.: 18/856,668

(22) PCT Filed: Apr. 3, 2023
(86) PCT No.: PCT/EP2023/058632

§ 371 Date: Oct. 14, 2024

(30) Foreign Application Priority Data
Apr. 14, 2022 (DE) 10 2022 203 782.0

(51) Int. Cl. H01M 8/2404; H01M 8/04298; H01M 8/04537; H01M 8/04664

(52) U.S. Cl. CPC H01M 8/2404; H01M 8/04305; H01M 8/04552; H01M 8/04671

(57) ABSTRACT

The presented invention relates to a production method (100) for producing a fuel cell stack. The production method (100) comprises producing (101) a number of fuel cells in a production line (201) by a plurality of production steps, determining (103) voltage values of a voltage of an individual fuel cell of the number of fuel cells from a start time, at which a fuel supply to the fuel cell is interrupted, to an end time, assigning (105) the voltage values to a first group, which describes a fault-free condition of the fuel cell, or to a second group which describes a faulty state of the fuel cell, by means of a machine learner, sorting out (107) fuel cells with voltage values assigned to the second group by the machine learner, and assembling (109) only fuel cells with voltage values assigned to the first group by the machine learner into a fuel cell stack.

### BACKGROUND

The presented invention relates to a production method and a production system for producing a fuel cell stack.

According to the prior art, during production, fuel cells are tested by means of individual tests specific to a respective production point by comparing the respective measured values determined with the specified test limits. Fuel cells with measured values showing an excessive deviation from the test limits are sorted out.

### SUMMARY

In the context of the invention presented, a production method and a production system for producing a fuel cell stack are presented. Further features and details of the invention arise from the respective dependent claims, the description, and the drawings. In this context, features and details described in connection with the production method according to the invention clearly also apply in connection with the production system according to the invention, and respectively vice versa so that, with respect to the disclosure, mutual reference to the individual aspects of the invention is or can always be made.

The present invention serves in particular to provide a robust fuel cell system.

Therefore, according to a first aspect of the present invention, a production method for producing a fuel cell system is presented.

The production method comprises producing a number of fuel cells in a production line through a plurality of production steps, determining the voltage values of a voltage of an individual fuel cell of the number of fuel cells from a start time, at which a fuel supply to the fuel cell is interrupted, to an end time, assigning the voltage values to a first group, which describes a fault-free condition of the fuel cell, or to a second group which describes a faulty state of the fuel cell, by means of a machine learner, sorting out fuel cells with voltage values assigned to the second group by the machine learner and assembling only fuel cells with voltage values assigned to the first group by the machine learner into a fuel cell stack.

In the context of the invention presented, a faulty condition means a fuel cell condition that is abnormal and results in premature aging or reduced service life compared to a normal condition, respectively.

The invention presented is based on the principle that a behavior of a fuel cell is determined based on a voltage curve at the end of an operational cycle of the fuel cell, the so-called “bleed-down,” in which a supply of fuel to the fuel cell is interrupted and used to assess a state of the fuel cell. For this purpose, the voltage curve of an individual fuel cell is evaluated from a start time at which a fuel supply to the fuel cell is interrupted to an end time, such as a predetermined operating state or a predetermined time interval from the start time, which may last, for example, one second.

According to the present invention, a machine learner is used to assess a state of a fuel cell, and assigns voltage values determined during the “bleed-down,” i.e., a plurality of voltage values or a curve of voltage values, to a first group that describes a fault-free state or to a second group that describes a faulty state. Accordingly, the machine learner automatically detects faulty and fault-free fuel cells.

By using the machine learner, predetermined test limits may be dispensed with so as to minimize the number of fuel cells incorrectly detected as faulty. Instead, faulty or abnormal fuel cells are detected using assignment logic which is learned and continuously adapted by the machine learner.

In particular, it is provided that only voltage values and correspondingly no so-called “label data,” i.e., ground truths for training the machine learner, which are predetermined by a user, are transmitted to the machine learner.

In particular, it can be provided that an error message is output on an output unit, such as a display and/or a speaker, in the event that the machine learner assigns the voltage values to the second group and not the first group, respectively. This means that if a faulty fuel cell is detected, an error message is output.

If voltage values are assigned to the second group, this indicates an abnormality in a behavior or construction of an individual fuel cell, such as a gas leak or a change in electronic conductivity, such as a short circuit, such that a defect in the fuel cell is likely in the near future and a corresponding indication of an expected defect can be output.

It may be provided that the end time is predetermined or determined dynamically depending on the start time.

A dynamically determined end time may be, for example, a time selected depending on an operating state of the fuel cell system, such that the end time changes depending on an operating state currently set in the fuel cell system. An assignment scheme may be specified for this purpose, for example, that associates individual operating states with respective end times.

It may be provided that the machine learner comprises an unsupervised learning model that continuously and autonomously updates parameters leading to assignment of voltage values to the first group based on voltage values of different fuel cells supplied to the machine learner.

An unsupervised learning model is based on a core program that divides incoming data, in the present case voltage profiles, into groups during the “bleed-down.” In doing so, the core program itself defines differentiating features that result in assignment to a respective group. Accordingly, no physical contexts or models need be provided to the core program. Rather, the core program determines these contexts itself and thereby defines what is to be understood as a first group and a second group. In so doing, the definition of the first group as a fault-free condition of the fuel cell is carried out descriptively, in that the core program receives more data from fuel cells in a fault-free condition than data from fuel cells in a faulty condition. Accordingly, the first group is formed from voltage values scattering in a normal range, while the second group relates to voltage values that lie outside of the first group or a corresponding “point cloud.”

The unsupervised learning model is not provided with pre-sorted voltage data for training purposes. Rather, the unsupervised learning model is trained only on the basis of voltage data, which is also provided as an input signal to the unsupervised learning model in real-world operation.

For example, a so-called “k-means algorithm,” an “expectation maximization algorithm” or a “density-based spatial clustering of applications with noise algorithm” may be used as an unsupervised learning model that forms groups of low variance and similar size.

It may be provided that the machine learner be trained on faulty fuel cells.

In order to enable the machine learner provided according to the invention to distinguish accurately between a fault-free fuel cell and a faulty fuel cell or a classification of voltage values to the first group or the second group, input values can be provided to the machine learner in the embodiment of the invention presented which are determined from faulty fuel cells, such that the machine learner can adapt its underlying mathematical model accordingly.

It may be provided that, in the event that the machine learner assigns voltage values determined on a particular fuel cell to the second group, a faulty production warning is assigned to the fuel cell.

A warning, such as an error message output on a display or speaker, can inform a user that the respective fuel cell has been assigned to the second group by the machine learner, so that the user can remove the fuel cell from a production process, for example, or deliver it to a reworking process.

It may further be provided that the voltage values are pre-processed by means of a mathematical method.

Pre-processing, during which dimensions by which the machine learner can carry out the assignment, for instance, are defined in advance, can maximize the machine learner's accuracy and assignment speed, as the number of potentially available dimensions is reduced.

It may further be provided that the at least one mathematical method comprises a correlation of voltage values and a number of predetermined geometric parameters.

Pre-processing in which geometric parameters, in particular outliers and/or patterns, are predetermined makes it possible to omit test limits for identifying faulty fuel cells, so that a number of incorrectly detected fuel cells is minimized.

It may further be provided that an intervention limit above which an error message is output is determined using the method of least squares.

An intervention limit makes it possible to avoid the output of an error message for minor deviations in the voltage values, which for example are within an admissible error tolerance.

It may further be provided that the intervention limit will be progressively lowered as the number of production cycles carried out increases.

As the intervention limit is progressively lowered, the machine learner is progressively trained and increasingly used as the decision maker for whether to output an error message. Accordingly, an untrained machine learner is protected from a false negative decision by a high intervention limit and a trained machine learner is required to make decisions more often by a low intervention limit. In this process, a new untrained machine learner may be pre-configured by a computational model predetermined by a central database, such that the machine learner may further refine the provided computational model and adjust it to specific circumstances in a particular fuel cell system.

According to a second aspect, the presented invention relates to a production system for producing a fuel cell stack.

The production system includes a production line and a computing unit, wherein the computing unit is configured to perform a possible configuration of the presented production method.

In the context of the invention presented, a computing unit is understood to mean a computer, in particular a processor or a sub-processor, or any other programmable circuit.

### BRIEF DESCRIPTION OF THE DRAWINGS

Further advantages, features, and details of the invention arise from the following description, in which exemplary embodiments of the invention are described in detail with reference to the drawings. In this context, the features mentioned in the claims and in the description can each be essential to the invention individually or in any combination.

Shown are:

FIG. 1 a schematic representation of a possible configuration of the production method presented.

FIG. 2 a schematic representation of a possible configuration of the production system presented.

### DETAILED DESCRIPTION

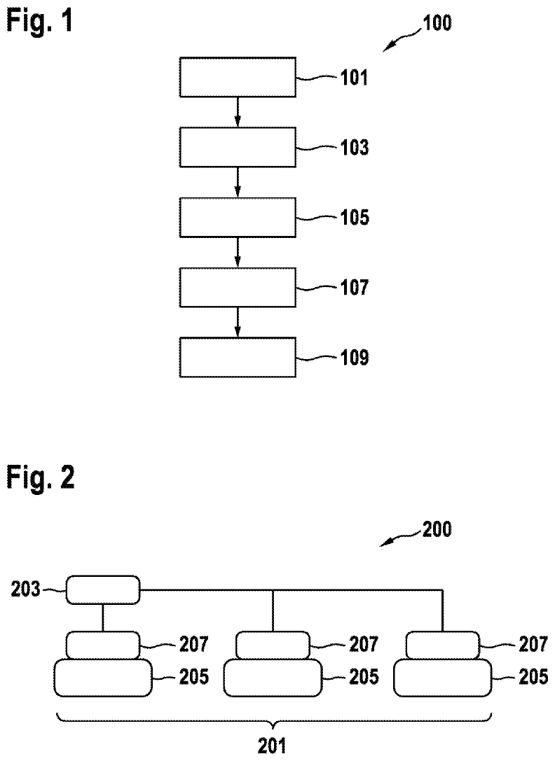

FIG. 1 shows a production method 100. The production method 100 comprises a production step 101, wherein a number of fuel cells are produced in a production line by a plurality of production steps, a determining step 103, during which the voltage values of a voltage of an individual fuel cell of the number of fuel cells is determined, from a start time, at which a fuel supply to the fuel cell is interrupted, to an end time, an assignment step 105, wherein the voltage values are assigned by means of a machine learner to a first group, which describes a fault-free condition of the fuel cell, or to a second group which describes a faulty state of the fuel cell, a sorting step 107, in which the fuel cells whose voltage values are assigned to the second group by the machine learner are sorted out, and an assembly step 109, in which only fuel cells whose voltage values have been assigned to the first group by the machine learner are assembled into a fuel cell stack.

In particular, the machine learner may be configured to perform so-called “end-of-line” electrochemical measurements, such as to use “bleed down times” or corresponding point clouds of measured values as the basis for assigning the measured values to one of at least two groups, and to detect or differentiate faulty fuel cells from fault-free fuel cells. To this end, the machine learner can, for example, determine geometrical dimensions, such as spacing, compliance with tolerance, etc. or have these dimensions transmitted to it as input parameters.

Accordingly, the machine learner recognizes characteristics that result in abnormal bleed down values or particularly low current/voltage values, such that corresponding fuel cells can be sorted out and discarded prior to being assembled into a fuel cell stack.

FIG. 2 shows a production system 200. The production system 200 comprises a production line 201, such as a number of machines 205, in particular a number of production robots, and a computing unit 203. The computing unit is configured to perform the production process 100. For example, the computing unit 100 may be connected to sensors 207 on the production line and control individual machines 205 of the production line such that they discard a fuel cell that is currently being processed when it is assigned to the second group by the machine learner or detected as faulty. Amendments to the Claims Please amend the listing of claims as follows:

1. A production method (100) for producing a fuel cell stack, wherein the production method (100) comprises:
producing (101) a number of fuel cells in a production line (201) by a plurality of production steps,
determining (103), via a computer, voltage values of a voltage of an individual fuel cell of the number of fuel cells from a start time at which a fuel supply to the fuel cell is interrupted to an end time,
assigning (105), via the computer, the voltage values to a first group that describes a fault-free state of the fuel cell or to a second group that describes a faulty state of the fuel cell by means of a machine learner,
sorting out (107), via the computer, fuel cells with voltage values assigned to the second group by the machine learner, and
assembling (109) only fuel cells with voltage values assigned to the first group by the machine learner into a fuel cell stack.

2. The production method (100) according to claim 1,
wherein
the end time is predetermined or determined dynamically depending on the start time.

3. The production method (100) according to claim 1,
wherein
the machine learner comprises an unsupervised learning model that continuously and autonomously updates parameters leading to an assignment of voltage values to the first group based on voltage values of different fuel cells supplied to the machine learner.

4. A production method (100) according to claim 1,
wherein
the machine learner is trained on faulty fuel cells.

5. A production method (100) according to claim lone of the preceding claims,
wherein
in the event that the machine learner assigns voltage values determined on a particular fuel cell to the second group, a faulty production warning is assigned to the fuel cell.

6. A production method (100) according to claim 5,
wherein
an intervention limit at which a warning is assigned to the individual fuel cell is determined by the method of least squares.

7. A production method (100) according to claim 6,
wherein
the intervention limit is progressively lowered as the number of production cycles performed increases.

8. A production method (100) according to claim 1,
wherein
the voltage values are pre-processed by at least one mathematical method.

9. A production method (100) according to claim 8,
wherein
the at least one mathematical method comprises a correlation of voltage values and a number of predetermined geometric parameters.

10. A production system (200) for producing a fuel cell stack, wherein the production system comprises:
a production line (201),
a computing unit (203),
wherein the computing unit (203) is configured to
determine (103) voltage values of a voltage of an individual fuel cell of the number of fuel cells from a start time at which a fuel supply to the fuel cell is interrupted to an end time,
assign (105) the voltage values to a first group that describes a fault-free state of the fuel cell or to a second group that describes a faulty state of the fuel cell by means of a machine learner.
sort (107) fuel cells with voltage values assigned to the second group by the machine learner, and
assemble (109) only fuel cells with voltage values assigned to the first group by the machine learner into a fuel cell stack.
